(19) United States
(12) Patent Application Publication
(10) Pub. No.: US 2024/0328239 A1
(43) Pub. Date: Oct. 3, 2024

(54) BRIDGE STRUCTURE AND METHOD OF PROVIDING A SMOOTH TRANSITION WAY ACROSS A THRESHOLD BY MEANS OF THE BRIDGE STRUCTURE

(71) Applicant: Excellent Holding ApS, Mørke (DK)

(72) Inventor: Ole Frederiksen, Hornslet (DK)

(21) Appl. No.: 18/618,335

(22) Filed: Mar. 27, 2024

(30) Foreign Application Priority Data
Mar. 31, 2023 (DK) PA 2023 70161

(51) Int. Cl. E06B 1/70; E06B 7/28

(52) U.S. Cl. CPC E06B 1/70; E06B 7/28

(57) ABSTRACT

A bridge structure suitable to provide a smooth transition way across a threshold in a doorway is provided, including a first ramp structure, where a first height along a first side in use substantially corresponds to or is higher than the height of the threshold and a height along a second opposing side which is as shallow as possible; a bridge element, including a first bridge part fastened to the first ramp structure, where the first bridge part is mmpivotably connected to a second bridge part, where the bridge element includes one or more layers of tile and/or ramp elements, where the first bridge part has a first inclined part and where the second bridge part has a straight part and a second inclined part, that connects the upper straight part or first inclined part with a surface in use outside of the door.

### CROSS-REFERENCE TO RELATED APPLICATIONS

This application claims priority to Danish Application No. PA 2023 70161, having a filing date of Mar. 31, 2023, the entire contents of which are hereby incorporated by reference.

### FIELD OF TECHNOLOGY

The following relates to a bridge structure used for traversing thresholds particularly in door openings. Furthermore, a method for installing such a bridge structure is disclosed.

### BACKGROUND

In many households it is common to separate rooms with a door having a door frame. Part of the door frame is a threshold. The doorframe is typically constructed such that the door itself will be received in a recess in the frame in order to render the door closed. The threshold is typically elevated with respect to the surrounding floor surfaces. Particularly for wheelchair users and other users being challenged moving around, the thresholds are a challenge to pass.

It is known to build ramps on either side of the threshold in order to ease the passage of a threshold. However, for external doors the problem is greater. Typically, the door frame is larger incorporating weather seals etc. Likewise, the threshold is larger and often includes a plurality of recesses in order to accommodate weather seals, locking mechanisms etc. A normal ramp construction does not interfere with the door frame construction as this will cause problems opening and closing the door. However, particularly for doors opening to the outside having the larger thresholds this is inconvenient as passage of the threshold is cumbersome and uncomfortable and may cause stress to a user. Therefore, there is a need for a structure which allows a user to pass a threshold smoothly and without causing anxiety and at the same time does not interfere with the proper functioning of the door construction.

### SUMMARY

An aspect relates to a bridge structure suitable to provide a smooth transition way across a threshold in an openable doorway, where the bridge structure comprises:
a first ramp structure suitable to be arranged on the opposite side of a door to which the door opens, where the first ramp structure is built up from one or more layers of ramp elements and optionally tile elements, assembled to provide a first section of an inclined ramp having a substantially upper smooth transition surface, where a first height along a first side in use substantially corresponds to or is higher than the height of the threshold and a height along a second opposing side which is as shallow as possible;
a bridge element, comprising a first bridge part fastened to the first ramp structure, where the first bridge part by a hinge is pivotably connected to a second bridge part, where the bridge element comprises one or more layers of tile and/or ramp elements, where the bridge element has an upper surface and a lower surface, where the first bridge part has a first inclined part and optionally a straight part where the first bridge part has a maximum thickness and where the second bridge part has a straight part and a second inclined part, where the second inclined part connects the upper straight part or first inclined part with a surface in use outside of the door.

The provision of a hinge allows the bridge element to be pivoted relative to the first ramp structure. In this manner, when the door is closed the bridge element is brought into a position, typically inside the house, where it does not interfere with the door's proper operation. As the door is opened, the bridge element is pivoted outwards (relative to the room) and downwards until it comes into contact with the outside surface. As the first ramp is provided with an (upper) smooth transition surface which when the bridge element is lowered is flush with the upper surface of the bridge element's upper surface, a smooth transition way is provided across the threshold. The pivoting of the bridge element furthermore assures that the bridge structure does not interfere with the door. A further advantage is that the door, door frame or immediate surroundings of the door structure do not need to be modified, altered or in any other way interfered with.

A further aspect indicated by the assembling of the first ramp and the bridge element from separate elements such as tiles or ramp elements indicate that the bridge structure may easily be adapted to various thresholds, or various levels of adjoining surfaces to the threshold. Normally the outside surface will be substantially lower than the interior (floor) surface, and as such the bridge element will normally have a larger thickness than the first ramp structure. Embodiments of the invention therefore also foresee that the bridge element is made up of one or more ramp elements and one or more tile elements, where the tile elements are of the same type.

In this connection tiles or ramp elements of the same type shall be understood as tiles or ramp elements having substantially identical geometric dimensions. An example of such tiles and ramp elements may be the applicant's tiles and ramp elements, as disclosed on www.ex-as.com.

In an embodiment a support structure, suitable to be arranged on the side of a door to which the door opens up to is provided, the support structure having an underside and an upper surface, where the support structure has a height in use between the undersurface and the upper surface lower than the lowest point of the door, where the support structure is built from one or more tile elements in one or more layers and optionally ramp elements.

By providing a support structure-typically assembled from tile elements and having a surface area, it minimizes the level difference between the interior floor surface and the outside surface wherein the bridge element may have a lesser height. This is advantageous especially in the situation where the bridge part is pivoted into a substantially vertical position as the door is closed. By being able to make the bridge element slimmer, it takes up less space inside when not in use.

In an embodiment the ramp elements and tile elements have a surface plate defined by an upper side and a rear side, where the surface plate is continued along the edges with wall portions extending substantially orthogonal from the surface plate, the wall portions defining the thickness of the tile elements or ramp elements and where the surface plate is provided with a pattern of apertures, and where at least between some of the apertures extending from the rear side of the surface plate a number of support towers are provided.

With this construction the tiles and ramp elements are provided with a relatively thin surface and (in use) downwards projecting side walls, also being relatively thin. The apertures serve a plurality of purposes. Firstly, they serve as drain openings allowing water to drain away from the surface thereby facilitating a clear and safe surface for traffic. In order to potentially improve the friction of the surface, the same applicant has a friction increasing rubber matrix which may be inserted from the rear side of the surface, slightly protruding, such that discrete rubber points are provided in the surface. Furthermore, the apertures allow superposed elements having similar apertures to be assembled by removable tile locks. By locking the elements in different layers together a stable almost monolithic construction is achieved providing a strong, rigid and stable platform or ramp construction. This feature is designated as an embodiment where a tile element or a ramp element is superposed another tile or ramp element, apertures in one element are superposed apertures in the other element and a locking key is inserted through overlapping apertures locking the two elements together.

Typically, as set out in an embodiment the tiles have a height of 15 to 20 mm, width between 400 to 800 mm, length between 400 to 800 mm. They may be manufactured from a plastic material, for example, a recycled base material. It is therefore possible by simple cutting to adapt the tiles and ramp elements to the geometric constraints at the place where the bridge structure is installed.

In order to pivot the bridge element into the lowered position where it is possible to traverse the bridge structure, a hoisting mechanism may be provided on the inside of the door frame. The hoisting mechanism may comprise a pulley and a string connected to a distal end of the bridge clement. By pulling the string the bridge clement is pivoted around the hinge, and by slacking the string the bridge element is lowered towards and into contact with the outside surface, creating a smooth transition way across the threshold. The hoisting mechanism may also be provided with an electrical winch optionally wirelessly controlled. This is advantageous for wheelchair users as the operation of the bridge structure thereby becomes easy to handle and operate.

Embodiments of the invention are also directed at a method of providing a smooth transition way across a threshold in an openable doorway by a bridge structure comprising the following steps:
a. Arranging an interior ramp structure on the floor on the opposite side of a door to which the door opens, where the interior ramp is built up from one or more ramp elements and optionally tile elements, in one or more layers, assembled to provide a first section of an inclined ramp having a substantially upper smooth transition surface, having a first height along a first side adjacent the threshold and a second height along a second opposing side is as shallow as possible thereby being substantially flush with the floor, and
b. If necessary arranging an exterior ramp and/or surface structure on the side of a door to which the door opens up to, the exterior ramp and/or surface structure having an underside arranged on a support surface and an upper surface, where the ramp and/or surface structure has a height in use between the undersurface and the upper surface lower than the lowest point of the door, where the exterior ramp structure is built from one or more tile elements in one or more layers and optionally ramp elements;
c. Arranging a bridge clement, comprising a first bridge part fastened to the interior ramp structure, where the first bridge part by a hinge is pivotably connected to a second bridge part, where the bridge clement comprises one or more layers of tile and/or ramp elements, where the bridge element has an upper surface and a lower surface, where the first bridge part has an inclined part and a straight part and between upper and lower surfaces of the straight part has a first thickness and where the second bridge part when the straight surfaces on the first and second bridge parts are flush, has a lower surface in contact with the support surface or the upper surface of the exterior ramp.

### BRIEF DESCRIPTION

Some of the embodiments will be described in detail, with references to the following Figures, wherein like designations denote like members, wherein:

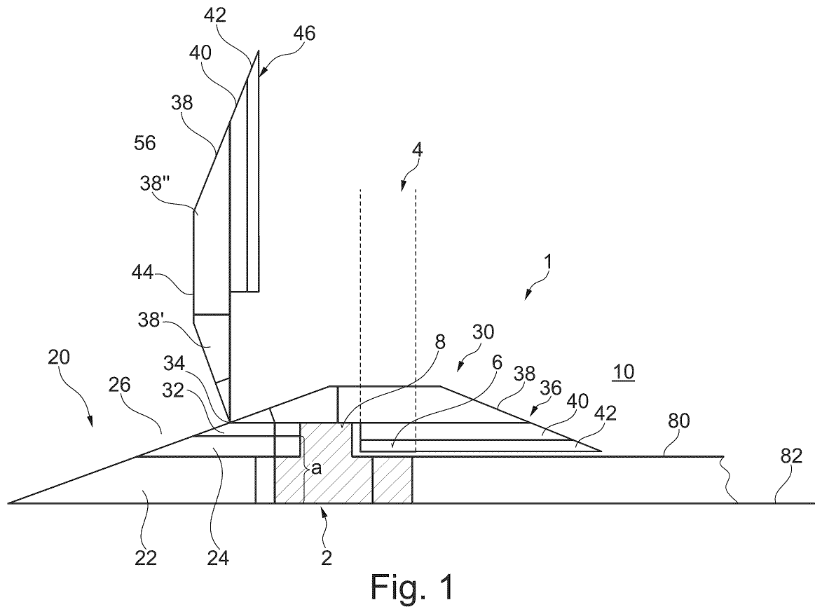

FIG. 1 illustrates a cross section through a bridge structure installed in a doorway;

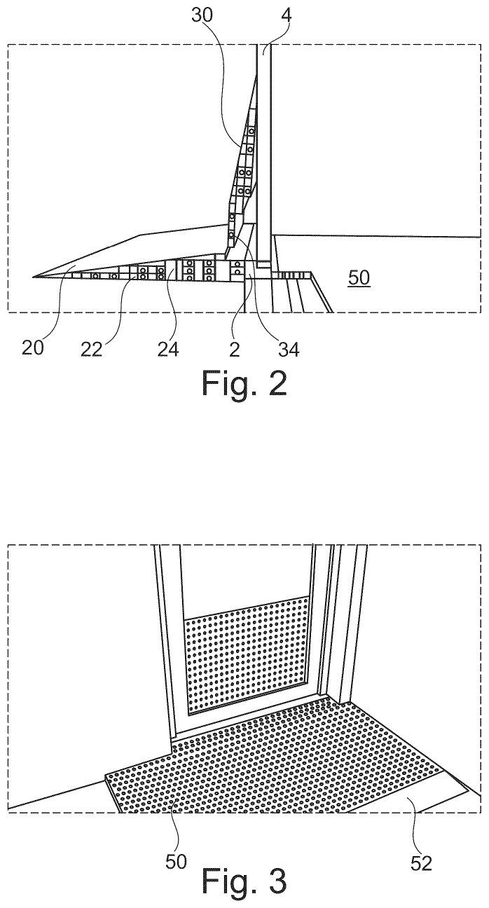

FIG. 2 illustrates bridge structure in a vertical position;

FIG. 3 illustrates a bridge structure installation when the door is closed;

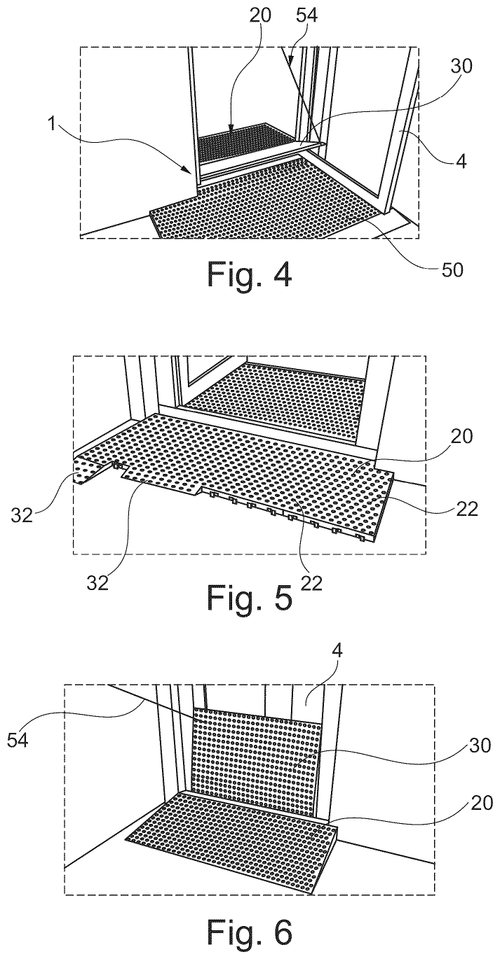

FIG. 4 illustrates a bridge structure installation when the door is open;

FIG. 5 illustrates an intermediate stage in constructing a bridge structure, where an interior ramp is being constructed and an outside ramp is present;

FIG. 6 illustrates an inside view with the bridge element in its raised position;

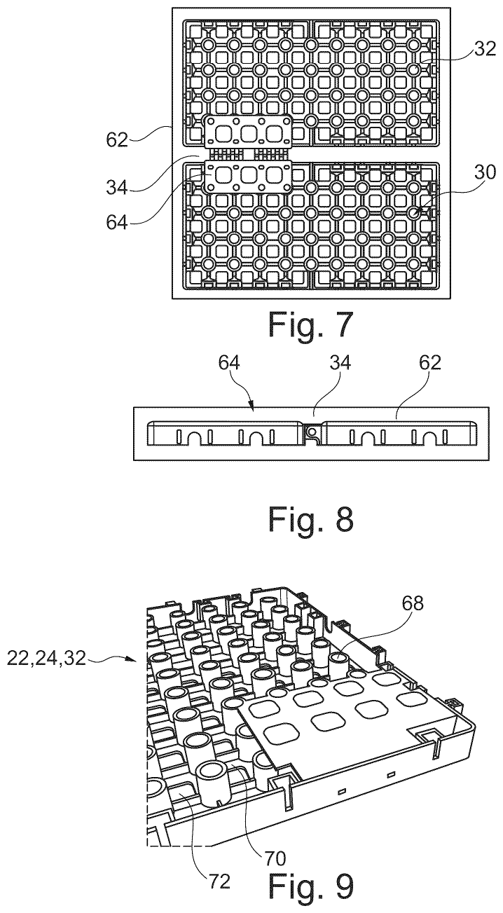

FIG. 7 illustrates the placement of a hinge in rear sides of adjacent tile elements;

FIG. 8 illustrates a cross section through adjacent tile elements connected by a hinge; and

FIG. 9 illustrates a rear view of a tile with (part of a) hinge inserted in the underside.

### DETAILED DESCRIPTION

In FIG. 1, a bridge structure 1 according to embodiments of the invention is schematically illustrated. In the illustration what will be called bridge element is elevated into a raised position in phantom lines and a lowered (use) position in normal lines. The bridge element pivots around a hinge. The purpose of the bridge structure is to provide a smooth transition way across a threshold 2 in an openable doorway 3. In this figure the door 4 is illustrated in dashed lines. The door 4 opens towards the outside 10. In order to provide an effective weather barrier, the threshold is provided with steps 6,8. The actual weather strips/seals are not illustrated. The door 4 will in its closed position be slightly elevated from the first step 6 and resting against the part of the threshold between the first step 6 and the upper step 8. For illustrative purposes a simple threshold only having a few steps is illustrated but the actual constitution of the threshold is not important for embodiments of the present invention, as only the outer geometrical dimensions of the threshold have any bearing on embodiments of the invention.

The bridge structure 1 comprises a first ramp structure 20 suitable to be arranged on the opposite side of a door 4 to which the door opens, where the first ramp structure 20 is built up from one or more layers 22,24 of ramp elements and optionally tile elements. In the bridge structure 1 illustrated in FIG. 1, no tile elements are included in the interior ramp, but it is clear that tile elements may be incorporated, for example if it is desirable to have a longer ramp/bridge inside the door. In this connection it is contemplated that tile elements and ramp elements have substantially the same heights, and possibly also length and width measurements. The ramp elements 22,24 (and possibly any tile elements) are assembled to provide a first section of an inclined ramp having a substantially upper smooth transition surface 26.

A bridge element 30, comprising a first bridge part 32 fastened to the first ramp structure 20 is by a hinge 34 pivotably connected to a second bridge part 36, where the bridge element 30 comprises one or more layers 38-44 of tile and/or ramp elements. In the illustrated embodiment the upper most tier/layer 38 of the bridge part 36 comprises two ramp elements 38′,38″, with oppositely inclined sides, such that in use when the bridge element 30 is lowered the elements 38′,38″ will form an apex.

The bridge element 30 has an upper surface 44 and a lower surface 46. As illustrated in FIG. 1 the first bridge part 32 has a first inclined part 32′ and optionally a straight part (not illustrated) where the first bridge part has a maximum thickness, and where the second bridge part has a straight part and a second inclined part, where the second inclined part connects the upper straight part or first inclined part with a surface in use outside of the door.

In FIG. 2 is illustrated a bridge structure as described above with reference to FIG. 1. In the illustrated embodiment in FIG. 2, the bridge element 30 is pivoted into a vertical position, by pivoting the bridge element 30 around the hinge 34. The hinge 34 is positioned in a horizontal distance from the door 4, such that the door 4 as illustrated may be closed (i.e. in engagement with the door frame and threshold) without the bridge structure interfering with the door's movement.

The first ramp structure 20 is arranged internally. In this embodiment the first ramp structure 20 comprises three layers of substantially identical tiles 22,24. Further ramp “tiles” are fitted to provide an even inclined surface. The first bridge part 32, with the hinge 34 is superposed the underlying tiles 22,24.

On the opposite side of the door, i.e., on the exterior side 10 is arranged a support structure or surface 50. The height of the surface above the outside level is adjusted so that the support structure does not interfere with the proper operation of the door 4. Furthermore, the bridge element 30 is dimensioned such that it will provide a smooth passage across the threshold 2 and come into contact with the surface, also providing a smooth transfer from the bridge structure 1 to the surface 50.

In FIG. 3 the support structure 50 is illustrated. In this embodiment the support structure is provided with ramp elements 52 along a free edge, in order to improve for example a wheelchair's passage.

In FIG. 4 a situation is illustrated where a bridge structure 1 is being made ready for use. A first ramp structure 20 is installed inside the door 4. The door 4 is open, whereby the bridge element 30 is allowed to pivot into a position where the underside of the bridge element 30 comes into resting contact with the support surface. In this figure the bridge element 30 is partly pivoted towards the support surface 50. A wire or string 54 is provided in order to manipulate the bridge element between the lowered position where the bridge element 30 is in contact with the support surface and a raised position where the bridge element 30 does not interfere with the door 4 as illustrated in FIG. 2.

In FIG. 5 is illustrated a partly assembled first ramp 20. The ramp is assembled from a number of tile elements 22, and a number of ramp elements 32. The tile and ramp elements 22,32 are made from a plastic material and may easily by “tailored” to fit door openings, walls etc. by simply cutting the tile or ramp elements.

In FIG. 6 a bridge structure 1 when not in use is illustrated. The bridge element 30 is elevated by pulling the wire/string 54. In this position the bridge element 30 is substantially vertical and allows the door 4 to be closed. By releasing the wire/string 54 the bridge element 30 may be pivoted downwards, see FIG. 4, until it comes into contact with the surface outside, which in the illustrated embodiments is in the shape of a support surface 50, but may also just be the outside surface as such.

In FIGS. 7 to 9 are illustrated the construction of the hinge and its position. In FIG. 7 is illustrated the rear side of adjacent upper-most tile or ramp elements 32,30. A hinge 34 is arranged fastened to both adjacent tiles or ramp elements 32,30. The hinge comprises two plates 62,64, connected by an axle 66, such that the two plates 62,64 may pivot relative to each other.

In FIG. 9 is illustrated the rear side of a desired tile element 22,24,32 usable with embodiments of the invention. The tile is typically formed from a plastic material, for example by injection molding. The tile comprises a relatively thin upper surface 70 which in this embodiment is provided with apertures 72. On the rear side of the tile, see FIG. 9 is provided a plurality of support towers 68. Along the outer edges of the tile is provided walls 74. The ramp elements are manufactured and designed similarly, such that they share general dimensions.

The hinge is fastened to the support towers 68 on both adjacent tiles 62,64. In this manner the hinge 34 as illustrated with reference to FIG. 8 showing a cross-section through two tiles 62,64, connected by a hinge 34, the hinge may be fitted to the rear of the tiles substantially without the use of tools (and may be removed again).

In order to properly install the bridge structure 1 as described above in order to provide a smooth transition way across a threshold in an openable doorway 4, an interior ramp structure 20 is placed on the floor on the opposite side of a door 4 to which the door opens. Depending on the normal building traditions which vary from area to area, an outside door will open inwards or outwards. In this example is described an example where the door opens outwards, meaning that the door will pivot towards the outside.

The interior ramp 20 is built up from one or more ramp elements and optionally tile elements 22,24 in one or more layers, assembled to provide a first section of an inclined ramp having a substantially upper smooth transition surface 26, having a first height along a first side adjacent the threshold 2 and a height along a second opposing side is as shallow as possible thereby being substantially flush with the floor. This construction will allow for example a wheelchair to smoothly traverse the structure 20 as it is an aim to avoid bumps or steep edges.

If necessary, an exterior ramp and/or surface structure 80 may be arranged on the side of the door 4 to which the door opens up to. The exterior ramp and/or surface structure 80 has an underside arranged on a support surface 82. The support surface 82 may for example be an outside pavement, terrace or the like. The exterior ramp 80 has an upper surface, where the ramp and/or surface structure has a height in use between the undersurface and the upper surface, lower than the lowest point of the door 4. In this manner it will be possible to open the door 4 without interfering with the ramp/support surface structure 80, and at the same time, the bridge element 30 may be made as shallow as possible.

The exterior ramp structure 80 may be built from one or more tile elements in one or more layers and optionally ramp elements.

Finally arranging a bridge element 30, comprising a first bridge part 32 fastened to the interior ramp structure 20, where the first bridge part 32 by a hinge 34 is pivotably connected to a second bridge part 36. The bridge element 30 comprises one or more layers of tile and/or ramp elements 40,42, where the bridge element 30 has an upper surface 36 and a lower surface. The first bridge part 32 has an inclined part and a straight part and between upper and lower surfaces of the straight part has a first thickness. The bridge element 30, and where the second bridge part when the straight surfaces on the first and second bridge parts are flush, has a lower surface in contact with the support surface 82 or the upper surface of the exterior ramp 80.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A bridge structure suitable to provide a smooth transition way across a threshold in an openable doorway, wherein the bridge structure comprises:
a first ramp structure suitable to be arranged on the opposite side of a door to which the door opens, wherein the first ramp structure is built up from one or more layers of ramp elements and optionally tile elements, assembled to provide a first section of an inclined ramp having a substantially upper smooth transition surface, wherein a first height along a first side in use substantially corresponds to or is higher than the height of the threshold and a height along a second opposing side which is as shallow as possible; and
a bridge element, comprising a first bridge part fastened to the first ramp structure, wherein the first bridge part by a hinge is pivotably connected to a second bridge part, wherein the bridge element comprises one or more layers of tile and/or ramp elements, wherein the bridge element has an upper surface and a lower surface, wherein the first bridge part has a first inclined part and optionally a straight part wherein the first bridge part has a maximum thickness and wherein the second bridge part has a straight part and a second inclined part, wherein the second inclined part connects the upper straight part or first inclined part with a surface in use outside of the door.

2. The bridge structure according to claim 1, wherein the bridge element is made up of one or more ramp elements and one or more tile elements, wherein the tile elements are of the same type.

3. The bridge structure according to claim 1, wherein a support structure, suitable to be arranged on the side of the door to which the door opens up to is provided, the support structure having an underside and an upper surface, wherein the support structure has a height in use between the undersurface and the upper surface lower than the lowest point of the door, wherein the support structure is built from one or more tile elements in one or more layers and optionally ramp elements.

4. The bridge structure according to claim 1, wherein the ramp elements and tile elements have a surface plate defined by an upper side and a rear side, wherein the surface plate is continued along the edges with wall portions extending substantially orthogonal from the surface plate, the wall portions defining the thickness of the tile elements or ramp elements and wherein the surface plate is provided with a pattern of apertures, and wherein at least between some of the apertures extending from the rear side of the surface plate a number of support towers are provided.

5. The bridge structure according to claim 1, wherein when a tile element or a ramp element is superposed another tile or ramp element, apertures in one element are superposed apertures in the other element and a locking key is inserted through overlapping apertures locking the two elements together.

6. The bridge structure according to claim 1, wherein the tiles have a height of 15 to 20 mm, width between 400 to 800 mm, length between 400 to 800 mm.

7. A method of providing a smooth transition way across a threshold in an openable doorway by a bridge structure, comprising:
a. arranging an interior ramp structure on the floor on the opposite side of a door to which the door opens, wherein the interior ramp is built up from one or more ramp elements and optionally tile elements, in one or more layers, assembled to provide a first section of an inclined ramp having a substantially upper smooth transition surface, having a first height along a first side adjacent the threshold and a height along a second opposing side is as shallow as possible thereby being substantially flush with the floor, and
b. if necessary arranging an exterior ramp and/or surface structure on the side of the door to which the door opens up to, the exterior ramp and/or surface structure having an underside arranged on a support surface and an upper surface, wherein the ramp and/or surface structure has a height in use between the undersurface and the upper surface lower than the lowest point of the door, wherein the exterior ramp structure is built from one or more tile elements in one or more layers and optionally ramp elements;
c. arranging a bridge element, comprising a first bridge part fastened to the interior ramp structure, wherein the first bridge part by a hinge is pivotably connected to a second bridge part, wherein the bridge element comprises one or more layers of tile and/or ramp elements, wherein the bridge element has an upper surface and a lower surface, wherein the first bridge part has an inclined part and a straight part and between upper and lower surfaces of the straight part has a first thickness and wherein the second bridge part when the straight surfaces on the first and second bridge parts are flush, has a lower surface in contact with the support surface or the upper surface of the exterior ramp.

8. The method according to claim 7, wherein the hinge is arranged at a distance “a” in use from the inside of a door, such that the bridge element in its raised position does not interfere with the proper closing of the door.
